(19) United States
(12) Patent Application Publication
(10) Pub. No.: US 2002/0057581 A1
(43) Pub. Date: May 16, 2002

(54) Active remote power feeding through communication line of one pair of wires

(76) Inventor: Ronen Nadav, Kfar Ganot (IL)

Correspondence Address: RONEN NADAV, 66 KFAR GANOT, KFAR GANOT, 50293, IL

(21) Appl. No.: 09/985,706

(22) Filed: Nov. 6, 2001

Related U.S. Application Data
(60) Provisional application No. 60/245,557, filed on Nov. 6, 2000.

(51) Int. Cl. H02M 3/335

(52) U.S. Cl. 363/16

(57) ABSTRACT

This invention provides an active solution for the problem of remote power feeding on only one pair of communication wires. The invention is an active system of one power transmitter and one or more power receivers. Unlike mains power distribution networks, in this invention, both power transmitter and power receivers maintain low impedance in the power pass band frequencies and high impedance in other communication bands with a sharp slop of impedance transition between bands. This behavior allows a parallel connection of the transmitters and receivers to an existing communication line with a negligible loading of communication signals. The system can be implemented with any type of pair of wires: twisted pair, parallel pair, coax etc.

The power waveform can be either DC or AC, depending on the application and the other signals sharing the same pair of wires. The frequency of the power carrier will be set to an unused range of the spectrum for the following purposes:

a. Minimizing interferences with other signals.

b. Achieving high impedance at the frequency of the power carrier at all other devices connected to the pair of wires.

An example for a typical use of the invention is an AC powering of a remote user device for supplying POTS, ISDN or ADSL services, through the existing pair of wires. The use of the said invention can power this device without interfering any of those services.

### REFERENCES CITED

My U.S. Patent provisional application Documents No: 60/245,557. Filing Date: November 6, 200 Ronen Nadav. Title: Active remote power feeding through communication line of one pair of wires.

### DESCRIPTION

An active remote AC or DC power feeding through a communication line of one pair of wires using a power transmitter and power receivers. The transmitter and receivers maintain low impedance at the power pass band frequencies and high impedance in other communication bands with a sharp slop of impedance transition between bands. The transmitter and receivers may optionally include a linear controlled power voltage source to improve high frequency impedance performance.

Power Transmitter

The transmitter includes:

a. A controlled power current source with a control system that stabilizes its voltage amplitude for all the allowed loading range of the receivers.

b. An optional Class D power amplifier to increase power efficiency.

The transmitter injects an electrical power through the pair of wires. It has a parallel connection to the wires. A power signal (most common a sine shaped) with a predefined amplitude and frequency will be added to the existing signals in the pair of wires. The transmitter does not load or interfere significantly with other signals propagating in the pair of wires. There is low impedance in a narrow bandwidth around the power carrier signal. An option for stopping the power carrier temporarily can be added. This can be done by monitoring the differential voltage of the pair of wires and sending a stop command to the power carrier generator if it exceeds a total voltage level. In this case, the receiver described below has sufficient energy storage for compensating the temporary lake of energy received.

Block diagram of the transmitter (FIG. 1):

1. A linear voltage controlled current source (VCCS) for power feeding through the pair of wires.

2. A linear voltage controlled voltage source (VCVS) connected in cascade with the current source. The using of this source is optional. It minimizes the voltage changes across the controlled current source to provide higher impedance of the controlled current source.

3. Class D power amplifier in cascade with the sources above. The amplifier will be used if the VCVS option is used. The Class D amplifier increases efficiency (reduces heat generated in the transmitter). The output of this amplifier must be aligned with the differential voltage in the pair of wires so the voltage appears across the linear controlled sources is the minimum needed for operation.

4. Signal generator or oscillator (most common a sine shaped signal) with a level control input to drive the controlled current source to the dynamically changed current level needed by the receiver or receivers.

5. Control loop that sets to a predetermined level the differential voltage level of the power carrier signal. The loop consist of:

5.1. Signal extractor (commonly a narrow filter) for sensing the voltage level of the power carrier.

5.2. A level detector at the output of the Signal extractor (commonly a half/full wave rectifier and a smoothing low pass filter).

5.3. Error amplifier and loop filter.

5.4. A constant reference voltage that used to set the power carrier level.

6. Passive interface to the pair of wires to improve impedance at high frequencies and prevent possible high frequency oscillations.

7. Floating power supply that can provide electrical power to the transmitter circuitry.

Power Receivers

The receivers include:

a. A controlled power current source synchronized in frequency and phase with the power carrier. It is done by a control system that determines dynamically the needed current amplitude.

b. A bi-directional Class D amplifier that tracks the voltage of the pair of wires. It accumulates the extracted electrical power and converts it to DC into a sufficiently large capacitor or rechargeable battery.

The receiver extracts the electrical power transmitted by the transmitter. It is a frequency selective. Therefore it can extract the electrical energy only from the power carrier. This is important for not loading or interfering significantly other signals propagating via the pair of wires. The receiver is an active device. Therefore, it will be powered in most applications from the same power carrier signal. There are two modes of operation:

a. Start-up mode (bypass mode): In this mode the receiver is not a frequency selective. It extracts electrical energy from all the signals sharing the pair of wires including the power carrier signal. The extracted energy is stored, in a capacitor or rechargeable battery, until it is sufficient for continuous operation of the receiver.

b. Operation mode (continuous): Frequency selective. Extracting electrical energy only from the power carrier signal. A supervising circuit can temporarily set the receiver again to the said start-up mode if the voltage across the accumulating capacitor is under a minimum threshold.

By monitoring the energy stored or voltage level in the storage device, a threshold circuit switches between the two modes. Another switching can be done by a predefined startup delay in the receiver. Each receiver consist of (FIG. 2):

1. A linear voltage controlled current source (VCCS) for passing the needed current at the power carrier frequency from the pair of wires to the power extractor.

2. A linear voltage controlled voltage source (VCVS) connected in cascade with the current source. The using of this source is optional. It minimizes the voltage changes across the controlled current source to provide higher impedance of the controlled current source.

3. Power extractor. Consist of a bi-directional Class D amplifier unit. This unit extracts power most commonly as a sine shaped current from the linear controlled current source and accumulates it as high voltage DC into a sufficiently large capacitor or rechargeable battery. This accumulated DC used to drive this class D amplifier to provide an AC output voltage aligned with the differential AC voltage of the pair of wires. Similar to the transmitter, this action minimizes the voltage across the controlled linear current sources to achieve good efficiency.

The power extractor is disabled during the startup mode and replaced by a full wave rectification circuitry.

4. DC/DC (Commonly switching and floating) power supply takes its energy from the DC storage of the power extractor and converts it to DC voltage levels needed for the auxiliary load and for internal circuitry.

5. Phase and frequency extractor of the power carrier (Commonly a narrow-band PLL) for sensing the frequency and phase of the power carrier alone. The clean output of this unit used to drive the controlled current source.

6. Startup circuitry with relay (or other devices) to bypass the linear controlled sources.

7. Control loop that determines the needed current to consume from the carrier power signal of the transmitter. The loop controls the input sine signal amplitude that goes to the controlled current source. This amplitude dynamically determined by keeping a predetermined level of average energy in the DC storage of the power extractor.

The controlled loop consist of:

7.1. Error amplifier and loop filter.

7.2. Constant voltage reference to determine the average energy level in the DC storage of the power extractor.

### SUMMARY OF THE INVENTION

The present invention provides an effective and efficient way to accomplish central power solutions to several devices connected via a common, single pair of wires so it can make use of an already present communication wire installation as POTS or alike. The installed system contains one power transmitter connected in parallel to a convenient outlet location, and several power receivers inside the user devices or at the outlets. Normally only one frequency selective trap should be used at the main entrance of the pair of wires to the building. Since the transmitter and receivers maintain low impedance at the power pass band frequencies and high impedance in other communication bands with a sharp slop of impedance transition between bands, there is negligible interference with the existing communication installation.

The transmitter and receivers make use of controlled current sources at the connecting points to the pair of wires instead of voltage sources commonly used at the mains power system. The frequency selective control converts them to voltage sources only at the power carrier frequency band.

The receiver can convert the AC power normally used for the power carrier to a useful DC power normally needed to electronic circuits. Since the receivers must be self powered from the same pair of wire, Start-up and supervising procedures and circuitry also included to ensure proper start-up and continuous uninterrupted power to the loads.

Safety means must be included if a high voltage carrier power is implemented. Such means must disable the transmitter fast and properly to prevent electrical hazard to a user. The transmitter can be disabled to some period of time without interrupting the power delivery to the loads at the receivers. The length of this period depends on the capability of the energy bank of the receiver to maintain the minimum DC voltage required for the loads and receivers circuitry.

### BRIEF DESCRIPTION OF THE DRAWINGS

In the drawings wherein like reference symbols refer to like parts:

FIG. 1 shows the Power Transmitter block diagram;

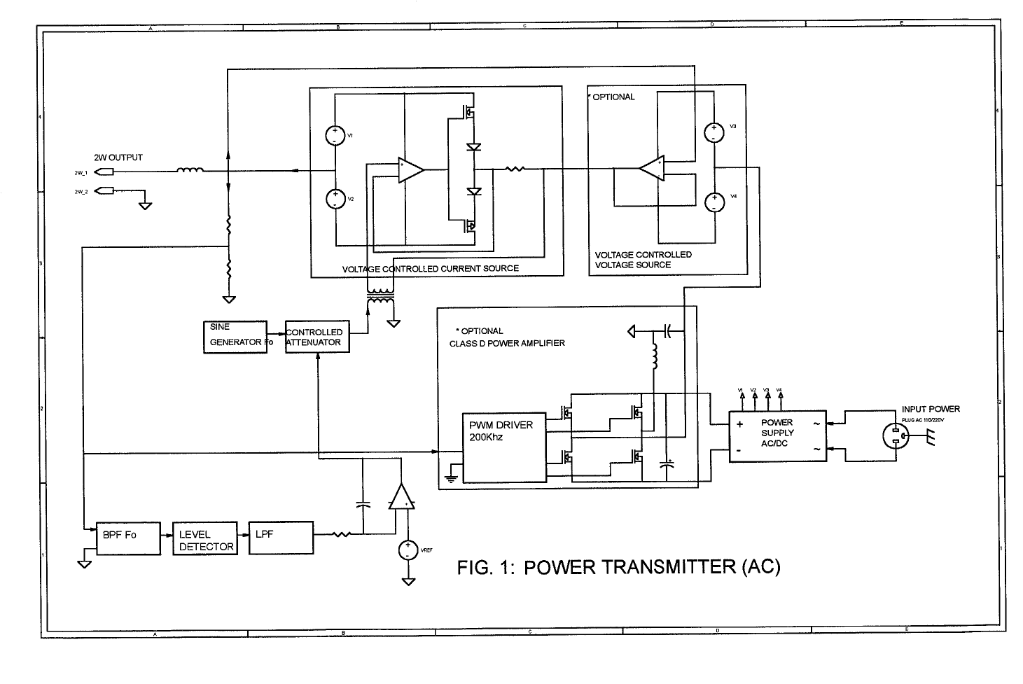

FIG. 2 shows the Power Receiver block diagram;

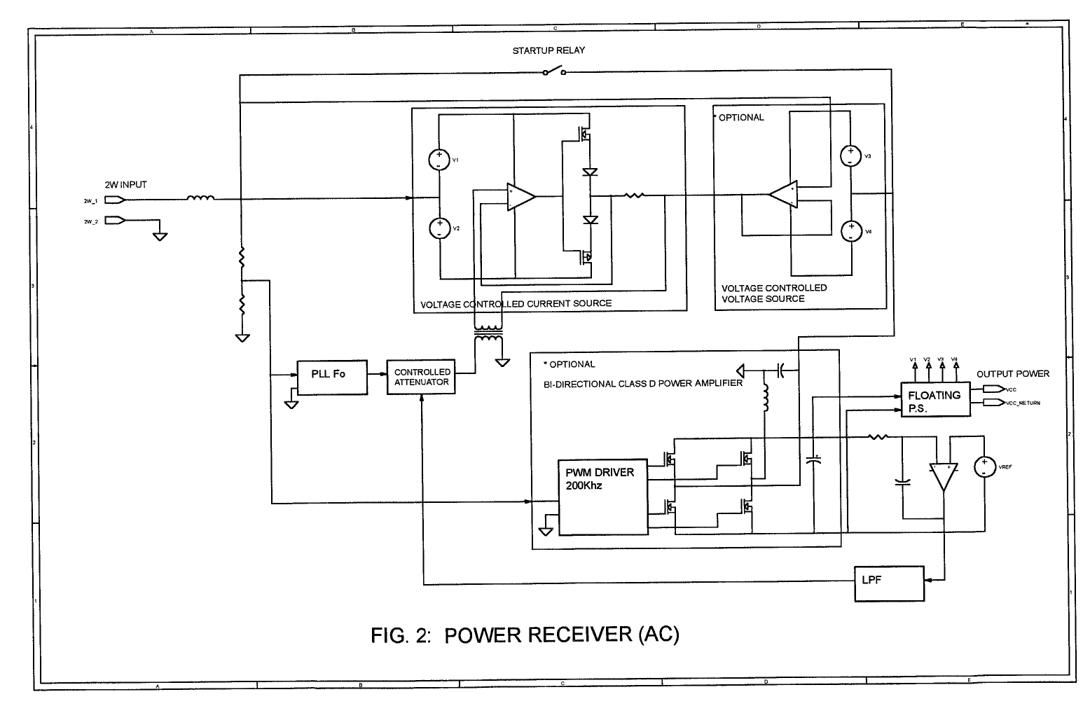

What is claimed is:

1. An apparatus and method for an active remote AC or DC power feeding through a communication line of one pair of wires using a power transmitter and one or several power receivers. The transmitter and receivers maintain low impedance at the power pass band frequencies and high impedance in other communication bands with a sharp slop of impedance transition between bands. The said transmitter includes:
a controlled power current source in parallel with the said pair of wires with a control system that stabilizes its voltage amplitude and frequency for all the allowed loading range of the receivers.
an optional Class D power amplifier to increase power efficiency.
The said receivers include:
a controlled power current source in series with the said pair of wires synchronized in frequency and phase with the power carrier. It is done by a control system that determines dynamically the needed current to consume from the power carrier.
a bi-directional Class D amplifier that tracks the voltage of the pair of wires. It accumulates the extracted electrical power and converts it to DC into a sufficiently large capacitor or rechargeable battery.

2. The said apparatus of claim one, wherein the said transmitter and receivers may optionally include a linear controlled power voltage source to improve high frequency impedance performance.

3. The said apparatus of claim one, wherein the control loop of the said transmitter makes use of a selective level detector that continuously measures the power carrier amplitude.

4. The said apparatus of claim one, wherein the said transmitter can contain fast disable circuitry and high voltage safety detecting means to protect the user from a potential electrical hazard.

5. The said apparatus of claim one, wherein the said receiver makes use of a PLL or harmonic tank for synchronizing the controlled power current source with the power carrier.

6. The said apparatus of claim one, wherein the said receiver powering is made by using a floating DC to DC converter powered from the accumulated voltage on the said capacitor or rechargeable battery.

7. The said apparatus of claim one, wherein a supervising circuit that continuously ensures that the voltage level at the said accumulating capacitor or battery is above a minimum threshold needed for a proper operation of the receiver circuits. Under this threshold the supervising circuit bypasses the current source so the said capacitor or battery can be charged directly from the pair of wires unselectively.

8. The said apparatus of claim one, wherein frequency selective traps can be used in series with some branches of the pair of wires to prevent the power carrier to enter to those branches that have no power receivers to eliminate unwanted loading, interference or safety problems.
